(19) United States
(12) Patent Application Publication
(10) Pub. No.: US 2026/0071333 A1
(43) Pub. Date: Mar. 12, 2026

(54) PRODUCTION OF HYDROGEN AND SOLID LITHIUM HYDROXIDE

(71) Applicant: Evonik Operations GmbH, Essen (DE)

(72) Inventors: Christian Hying, Rhede (DE); Elisabeth Gorman, Haltern am See (DE); Patrik Stenner, Hanau (DE); Sabrina Juretzka, Frankfurt am Main (DE); Tobias Stadtmüller, Seligenstadt (DE); Sebastian Arndt, Ginsheim Gustavsburg (DE); Frank Löffler, Heppenheim (DE); Huong Klink-Tran, Mannheim (DE); Jessica Antoni, Nidderau (DE); Nicole Decker, Bochum (DE); Meike Dahlhues, Marl (DE)

(21) Appl. No.: 19/110,774

(22) PCT Filed: Sep. 1, 2023
(86) PCT No.: PCT/EP2023/073981

§ 371 Date: Mar. 11, 2025

(30) Foreign Application Priority Data
Sep. 12, 2022 (EP) 22195063.7

(51) Int. Cl. C25B 1/16; C01D 15/02; C25B 1/04; C25B 9/19; C25B 13/07; C25B 15/08

(52) U.S. Cl. CPC C25B 1/16; C01D 15/02; C25B 1/04; C25B 9/19; C25B 13/07; C25B 15/083

(57) ABSTRACT

The problem addressed by the invention is that of specifying a process for producing lithium hydroxide that is very energy-efficient. The process should in particular manage without using thermal energy. As a raw material, the process should be able to process Li-containing waters that arise when used lithium-ion batteries are digested. The LiOH produced by the process should be of sufficiently high purity that it can be used directly for the production of new LIBs. The process should achieve a high throughput and have a low space requirement so that it can be combined with existing processes for reprocessing used LIBs or for producing new LIBs to form a closed, continuous production cycle. The process according to the invention is an electrolytic membrane process that is operated using an LiSICon membrane. A particular aspect of the process is that the electrolysis is operated up to the precipitation limit of the lithium hydroxide.

For the production of lithium-ion batteries (LIBs), lithium (Li) is by definition necessary. On account of its high reactivity, lithium occurs in nature not as the pure substance, but always in bound form. The starting material used for the production of LIBs is generally lithium in the form of lithium hydroxide (LiOH) or lithium carbonate (Li₂CO₃).

In most natural deposits Li is present in the form of lithium oxide (Li₂O) or salts such as lithium sulfate (Li₂SO₄) or lithium chloride (LiCl). Lithium oxide is a constituent of ores such as pegmatite, while lithium sulfate and lithium chloride are present in dissolved form in the leach liquors of Li salt lakes. In the course of the mining process, the lithium compound extracted in the particular case is converted into lithium carbonate (Li₂CO₃). In a further process step, the lithium carbonate can be converted into lithium hydroxide by reaction with quicklime or calcium hydroxide. The extraction of Li and its transformation into LiOH is described in:
Wietelmann, U. and Steinbild, M. (2014). Lithium and Lithium Compounds. In Ullmann's Encyclopedia of Industrial Chemistry, (ed.). DOI: 10.1002/14356007.a15_393.pub2

Rich Li deposits are known, but the production of LiOH from the Li compounds they contain is very energy intensive and generates large volumes of wastewater. There is also a strategic need to be free of dependency on the owners of the deposits.

One solution to this problem could be to reprocess the materials from spent LIBs so that the lithium contained therein can be reused as a raw material for new batteries.

Recycling processes for LIBs have already in the past been developed to industrial maturity, but were in most cases aimed at the metals Fe, Ni, Mn, Co, Mg and Al present therein. The alkali metal Li was not generally recovered, since its high reactivity makes it difficult to separate from scrap batteries and it was available at low cost in sufficient amount from natural deposits. The extraction of Li from used LIBs for a long time seemed simply uneconomical.

However, there is now growing social and economic pressure to recover lithium from used LIBs. In order for this idea to come to fruition, it is necessary for recycled lithium to be supplied to producers of LIBs in an acceptable quality such that the manufacturing processes for LIBs from recycled Li do not differ from those using mined virgin lithium. It goes without saying that there must be no adverse effect on battery quality. Recycled Li, especially in the form of LiOH, must consequently meet very stringent specifications as regards purity. In addition, the process for recovering Li from old batteries must be as energy-efficient as possible. The process should also use little water.

Known processes for recovering lithium from old batteries are collated in:
Pankaj K. Choubey et al.: Advance review on the exploitation of the prominent energy-storage element Lithium. Part II: From sea water and spent lithium ion batteries (LIBs), Minerals Engineering, volume 110, 2017, pages 104-121 DOI: 10.1016/j.mineng.2017.04.008.

A technology that is mentioned only in passing as “LISM” in the above review article is the electrolysis of Li-containing waters in the presence of what are known as LiSICon membranes.

LiSICon stands for lithium super ionic conductor. This is a class of inorganic glass-ceramic materials that are electrical insulators, but at the same time have an intrinsic conductivity for Li ions. The transport mechanism for Li derives from the crystal structure of the material. The Li ions are—in simplified terms—“passed through” the crystals. Commercially available LiSICon materials include lithium aluminium titanium phosphate (LATP), lithium aluminium titanium silicon phosphate (LATSP), lithium aluminium germanium phosphate (LAGP) and lithium lanthanum titanium oxide (LLTO). These materials were originally developed as solid-state electrolytes for LIBs. An overview of the transport mechanisms of LiSICons, their crystal structure and production is given in:
Palakkathodi Kammampata et al.: Cruising in ceramics—discovering new structures for all-solid-state batteries-fundamentals, materials, and performances. Ionics 24, 639-660 (2018) DOI: 10.1007/s11581-017-2372-7
Yedukondalu Meesala et al.: Recent Advancements in Li-Ion Conductors for All-Solid-State Li-Ion Batteries. ACS Energy Lett. 2017, 2, 12, 2734-2751 DOI: 10.1021/acsenergylett.7b00849

Specific LiSICon stoichiometries are described by:
Sofia Saffirio et al. Li_{1.4}Al_{0.4}Ge_{0.4}Ti_{1.4}(PO₄)₃ promising NASICON-structured glass-ceramic electrolyte for all-solid-state Li-based batteries: Unravelling the effect of diboron trioxide, Journal of the European Ceramic Society, volume 42, issue 3, 2022, pages 1023-1032 DOI 10.1016/j.jeurceramsoc.2021.11.014.
Eongyu Yi et al. Materials that can replace liquid electrolytes in Li batteries: Superionic conductivities in Li_{1.7}Al_{0.3}Ti_{1.7}Si_{0.4}P_{2.6}O₁₂. Processing combustion synthesized nanopowders to free standing thin films. Journal of Power Sources, volume 269, 2014, pages 577-588, DOI 10.1016/j.jpowsour.2014.07.029.

Their selective conductivity for Li ions means that LiSICon materials can be used as a membrane for separating Li from Li-containing mixtures. The Li must be present in the mixture in ionic form, for instance as an Li salt dissolved in water. The driving force that is needed to push the Li ions through the LiSICon membrane is an electrical voltage. An electrochemical cell comprising two electrodes and an LiSICon membrane that divides the cells into two compartments is constructed for this purpose. In each compartment there is an electrode. The compartments are referred to as anodic or cathodic depending on the polarity of the electrode present in the respective compartment. An electrical voltage is applied to the electrodes and the anionic compartment is filled with the Li-containing water as anolyte. The cathodic compartment is filled with water as catholyte. The membrane passes the Li cations through to the cathode. The water in the cathodic compartment (catholyte) therefore becomes enriched with Li, while the water on the anodic side (anolyte) becomes depleted in Li. Such a process is termed membrane electrolysis.

Membrane electrolysis processes for extracting lithium with the aid of LiSICon membranes have already been described in the prior art.

For instance, Zhen Li et al. describe a process in which the weakly lithium-containing water of the Red Sea is used as a raw material:
Zhen Li et al.: Continuous electrical pumping membrane process for seawater lithium mining. Energy Environ. Sci., 2021, 14, 3152 DOI: 10.1039/d1ee00354b

The Zhen Li research group use LLTO as the membrane. The target product that is separated off is lithium phosphate (LisPO₄), which is suitable for the production of lithium iron phosphate (LFP) batteries. LIBs having a different cathode material, for example nickel-manganese-cobalt (NMC) or lithium manganese oxide (NMO), cannot be directly produced therewith.

Yang et al. have sought to extract metallic lithium directly from seawater with the aid of solar power, an LAGP membrane and a copper foil.
Sixie Yang et al.: Lithium Metal Extraction from Seawater. Joule, volume 2, issue 9, 2018, pages 1648-1651, DOI 10.1016/j.joule.2018.07.006.

US 2016/0201163 A1 describes the separation of Li ions from a brine such as seawater with the aid of LiSICon membranes. Proposed membrane materials are specifically Li₃N, Li₁₀GeP₂S₁₂, LaₓLi_{y}TiO₂, and Li_{1+x+y}Alₓ(Ti,Ge)₂₋ₓSi_{y}P_{3-y}O₁₂. The target product is lithium carbonate (Li₂CO₃).

WO 2019055730 A1 is likewise concerned with the separation of lithium with the aid of LiSICon membranes. LLTO, LAGP and LATP are specifically mentioned. The LiSICon material can be applied to a support structure. The chemical nature of the support structure is not described in detail. Similarly little is described as to how the application of the LiSICon to the support structure is to be effected. The separated target product is Li ions.

U.S. Pat. No. 9,222,148B2 also discloses the separation of lithium hydroxide by electrolysis on an LiSICon membrane and consequent precipitation of lithium hydroxide hydrate. A disadvantage of this process is that it requires an energy-intensive evaporation step to precipitate the lithium hydroxide.

US20120103826 A1 describes the electrodialytic separation of lithium hydroxide from contaminated streams with the aid of a LiSICon membrane. In order to achieve high purity, LiOH is precipitated from the brine. This makes use of the low solubility of LiOH in water than that of the foreign salts. The precipitate is then redissolved and introduced into the electrodialysis cell. The LiOH concentration in the catholyte of the electrodialysis cell is not specified in US20120103826 A1. The catholyte is diluted with water. A disadvantage of this process is that a laborious crystallization needs to be operated before the electrolysis and that the heat of crystallization is lost as a result of the redissolution of the precipitate. The process is accordingly technically laborious and energy-intensive.

In addition to the use of ceramic LiSICon membranes, electrolytic processes for the separation of lithium that operate with organic ion-exchange membranes have also been disclosed.

For instance, EP 3805428 A1 describes the electrolytic production of lithium hydroxide. As well as the electrolysis, an electrochemical conversion of the lithium into lithium hydroxide is also operated. To obtain the necessary reactants, water undergoes a simultaneous electrochemical splitting. This is done using a bipolar three-compartment cell with an ion-exchange membrane. The commercially available Asahi® AVV, Nafion® 902, Fumatech® FAB, Fumatech® FKB and Neosepta® CMB ion-exchange membranes are used. The chemical nature of these ion-exchange membranes is not disclosed in EP 3805428 A1, but they will in all likelihood be organic membrane materials. The three-compartment cell operates in acidic media. Used as the feed is water containing Li salts such as lithium sulfate (Li₂SO₄) or lithium chloride (LiCl) in particular.

A two-stage electrodialytic/electrolytic production of lithium hydroxide from aqueous lithium sulfate and/or lithium bisulfate with simultaneous water splitting is disclosed in U.S. Pat. No. 10,036,094 B2. The first stage employs an electrochemical cell having two compartments and the second stage a three-compartment cell. The cells are equipped with ion-exchange membranes. The chemical composition of the ion-exchange membranes is not given. The following commercial membranes are mentioned: Fumatech® FAB, Astom® ACM, Asahi® MV, Nafion® 324 and Astom® AHA.

A fundamental drawback of polymer membranes is their permeability to water. This results in dilution of the anolyte with water from the catholyte. Dewatering of the target product is then necessary, which in turn consumes thermal energy or limits the location of the plant to regions with plenty of sunlight.

A further fundamental drawback of organic ion-exchange membranes besides their water permeability is that they have lower ion selectivity than inorganic LiSICon materials: They allow not just Li⁺, but also Na⁺ to pass through, thereby lowering the purity of the target product when Na is also present in the feed. As well as the purity of the target product, the electricity efficiency of the process also suffers as a result: If the electrolysis is carried out using a non-ion-selective membrane, the transport of unwanted Na⁺ to the second compartment will also consume valuable electrical energy. Moreover, on reaching the second compartment the Na⁺ will be converted into unwanted by-products by means of unintended electrochemical processes. The energy efficiency of the process based on the yield of the target product Li is reduced.

Lastly, organic membranes are sensitive to the presence of divalent cations such as Mg²⁺ and Ca²⁺. Over time these cations poison the membrane, thereby limiting the service life of organic ion-exchange membranes.

The glass-ceramic LiSICon materials promise better ion selectivity. However, the stability of the LiSICon membranes to impurities continues to be a highly significant problem for industrial practice here. For instance, the Li⁺-containing water generated in the reprocessing of used LIBs contains other cations such as Na⁺ and K⁺ in particular, which cause lasting damage to the LiSICon material: These cations appear to occupy the defects in the crystal structure, thereby bringing transport of the Li⁺ cations through the membrane to a virtual standstill. The service life of the electrochemical cell is then expired. The high cost of the LiSICon material means that recycling of Li from LIBs is uneconomical if the service life of the membrane is short. Also, the brine from Li salt lakes has a naturally high sodium content and therefore cannot be allowed to come into contact with known LiSICon membranes. Lithium from salt lakes therefore additionally undergoes an energy-intensive thermal separation and/or a stepwise process using large volumes of water in which it is dissolved and then recrystallized. Although the water can here be evaporated by solar radiation, the water to dissolve the LiCl is scarce in the deserts of South America. This route is thus highly problematic there.

Another practical problem is the high specific electrical resistance of the LiSICon material. This results in the electrochemical cell having a high ohmic internal resistance, which means that the process has a correspondingly high electrical energy requirement. To lower this, the membrane can in theory be made thinner. However, the low thickness of the material would in turn afford it only a short lifetime in aggressive environments.

In the light of this prior art, the problem addressed by the invention is that of specifying a process for producing lithium hydroxide that is very energy-efficient. The process should in particular manage without using thermal energy. As a raw material, the process should be able to process Li-containing waters that arise when used lithium-ion batteries are digested. The LiOH produced by the process should be of sufficiently high purity that it can be used directly for the production of new LIBs. The process should achieve a high throughput and have a low space requirement so that it can be combined with existing processes for reprocessing used LIBs or for producing new LIBs to form a closed, continuous production cycle. Lastly, the process should require as little fresh water as possible and give rise to little wastewater.

This problem is solved by a process according to claim 1.

The invention accordingly provides a process for producing hydrogen and lithium hydroxide, comprising the following steps:
a) providing a feed comprising at least water, Li ions and also impurities, the concentration of Li ions in the feed C_{F} being at least 200 ppm by weight or between 500 ppm by weight and 140 000 ppm by weight, in each case based on the total weight of the feed;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing at least one electrochemical cell, wherein the electrochemical cell has the following properties:
   i) the electrochemical cell includes a first compartment in which an anode is arranged;
   ii) the electrochemical cell includes a second compartment in which a cathode is arranged;
   iii) the electrochemical cell includes a membrane that separates the first membrane from the second membrane, the membrane having the area A;
   iv) the membrane comprises an inorganic material that possesses conductivity for Li ions and that is electrically insulating;
d) providing at least one electrical voltage source that is connected to the anode via a first electrical lead and to the cathode via a second electrical lead;
e) charging of the first compartment with the feed;
f) charging of the second compartment with the poor working medium;
g) charging of the electrochemical cell with an electrical voltage U drawn from the electrical voltage source such that an electrical current/flows between the anode and cathode, the ratio Q of the current strength of the electrical current/and the area A of the membrane being between 100 A/m² and 500 A/m² or between 150 A/m² and 350 A/m²;
h) withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F} based on the total weight of the feed;
i) withdrawing from the second compartment of a rich working medium comprising water, hydrogen and lithium hydroxide, the concentration of lithium hydroxide in the rich working medium C_{M1}, based on the total weight of the rich working medium, being greater than the concentration of lithium hydroxide in the poor working medium C_{M0} and the concentration of lithium hydroxide in the rich working medium C_{M1}, based on the total weight of the rich working medium, being greater than the solubility of lithium hydroxide in water at a temperature T_{M1}, where the temperature T_{M1} refers to the temperature of the rich working medium at the time of its withdrawal from the second compartment.

The process according to the invention is an electrolytic membrane process that is operated using an LiSICon membrane.

An important aspect of the process according to the invention is that the selective separation of lithium by the membrane and an electrolysis of water take place simultaneously in the cell. In the water electrolysis, water (H₂O) is split electrochemically into H₂ and O₂. At the cathode, OH⁻ and hydrogen are formed. The OH-anions are however unable to cross the LiSICon membrane and combine with the Li⁺ cations arriving in the cathodic compartment to form lithium hydroxide LiOH. At the anode, oxygen and H⁺ are formed.

The simultaneous operation of the Li+ membrane separation and the water electrolysis in the electrochemical cell with LiSICon membrane thus results in the direct formation of lithium hydroxide LiOH and molecular hydrogen H₂. Both are dissolved in water. The water containing the LiOH and the H₂ is withdrawn from the cathodic compartment of the cell. The LiOH is separated from the water. This makes it possible to extract an LiOH that-because of the selective migration of lithium ions through the membrane—has a purity sufficient for it to be used in battery production.

The hydrogen that is simultaneously evolved can be collected and used in the hydrogen economy. If the electrochemical cell is operated with green electricity, the process also leaves a small CO₂ footprint.

The feed needed for the combined Li separation and water electrolysis is a water containing Li⁺ cations. Such water is either generated during the reprocessing of used LIBs or else an Li brine from a natural deposit is used.

A key aspect of the process is that the electrolysis is operated up to the precipitation limit of the lithium hydroxide and beyond: This means that the concentration of lithium hydroxide in the rich working medium C_{M1}, based on the total weight of the rich working medium, is greater than the solubility of lithium hydroxide in water. The lithium hydroxide can thus precipitate as a solid in the catholyte, provided the necessary crystallization nuclei are present. Since these are always present in the form of minor impurities, at least part of the LiOH precipitates as a solid in the rich working medium (catholyte).

The point at which the lithium hydroxide in the catholyte precipitates as a solid depends on the operating conditions of the cell and on the presence of crystallization nuclei: The lithium hydroxide may already precipitate as a solid in the second compartment or it may precipitate only immediately after withdrawal of the rich working medium, i.e. only outside the cell. According to the invention, the rich working medium withdrawn from the second compartment always contains solid lithium hydroxide.

It is preferable that the rich working medium contains solid lithium hydroxide at the time of its withdrawal from the second compartment.

Solid lithium hydroxide optimally means lithium hydroxide in crystalline form. Since the lithium hydroxide crystal is also able to intercalate water, lithium hydroxide may also be present in gel form. In the gel, the lithium hydroxide forms a solid phase while the water forms a liquid phase. Gel formation is also determined by the residual impurities in the second compartment. This means that the precipitation of lithium hydroxide in gel form depends on the thermodynamic conditions in the second compartment and on the concentration of lithium hydroxide and impurities therein. A gel containing solid lithium hydroxide and liquid water is therefore also considered a solid for the purposes of the invention. The term “solid” therefore encompasses both a crystalline form and a gel.

The precipitation limit of lithium hydroxide in the second compartment is then reached when the concentration of lithium hydroxide in the rich working medium C_{M1} based on the total weight of the rich working medium is greater than the solubility of lithium hydroxide in water at a temperature T_{M1}, where the temperature T_{M1} refers to the temperature of the rich working medium at the time of its withdrawal from the second compartment.

This is because the solubility of lithium hydroxide in water, like that of most water-soluble inorganic solids, is temperature dependent. The exact position of the precipitation limit thus depends on the temperature of the rich working medium. The invention takes account of the temperature T_{M1} at which the rich working medium is withdrawn from the second compartment. The temperature T_{M1} is optimally between 20° C. and 60° C. This temperature corresponds in the simplest case to the operating temperature of the electrochemical cell. It is however also conceivable to operate the cell at a higher temperature and to cool the rich working medium to T_{M1} immediately before or during withdrawal. However, this does not always make sense energetically.

The solubility of lithium hydroxide in water is in practice also dependent on the purity of the water. If this contains impurities, these act as crystallization nuclei and promote precipitation of the lithium hydroxide.

Ultimately, it also makes a difference whether the lithium hydroxide concentration is calculated in the form of its anhydride (LiOH) or in the form of its monohydrate (LiOH·H₂O).

This all obviously results in the reported solubility of lithium hydroxide not being consistent in either the scientific literature or in patent applications.

A comprehensive overview of the solubility of lithium hydroxide in water is presented by Monnin and Dubois:
Christophe Monnin and Michel Dubois: Thermodynamics of the LiOH+H₂O System. Chem. Eng. Data 2005, 50, 4, 1109-1113 DOI 10.1021/je0495482

In addition, Monnin and Dubois have mathematically interpolated the values known from the literature.

The solubilities of lithium hydroxide in water at relevant temperatures according to various authors are shown in Table 1:

TABLE 1
Solubility of LiOH in water

| Temperature | | | Dittmar | D1 | S&M | Xie et al. | M&D | KirkOthmer* | Ullmann* |
|---|---|---|---|---|---|---|---|---|---|
| K | ° C. | ° F. | kg/kg | kg/kg | kg/kg | kg/kg | kg/kg | kg/kg | kg/kg |
| 293.15 | 20 | 68 | 0.1099 | 0.123 | | 0.128 | 0.134 | 0.191 | 0.216 |
| 313.15 | 40 | 104 | 0.1168 | | | 0.130 | 0.137 | 0.198 | 0.220 |
| 333.15 | 60 | 140 | 0.1276 | | 0.138 | 0.138 | 0.146 | 0.21 | 0.231 |
| 353.15 | 80 | 176 | 0.1421 | | 0.153 | 0.153 | 0.161 | 0.23 | 0.256 |
| 373.15 | 100 | 212 | 0.1605 | | 0.175 | 0.175 | 0.186 | 0.259 | 0.296 |

*Values according to Ullmann and KirkOthmer calculated as monohydrate, remaining values calculated as anhydride

The values shown in Table 1 originate from the following literature sources:
Dittmar: DOI https://doi.org/10.1016/0016-0032 (89) 90312-8
D1: US2012103826 A1
S&M: DOI https://doi.org/10.1021/je60015a018
Xie et al.: DOI https://doi.org/10.1016/j.seppur.2023.123972
M&D: DOI https://doi.org/10.1021/je0495482
KirkOthmer: DOI https://doi.org/10.1002/0471238961.1209200811011309.a01.pub2
Ullmann: DOI https://doi.org/10.1002/14356007.a15_393.pub2

With regard to the desired temperature range for T_{M1} of from 20° C. to 60° C., the concentration of lithium hydroxide in the rich working medium C_{M1}, based on the total weight of the rich working medium, is preferably above 0.1276 kg/kg (this is according to Table 1 the lowest reported solubility of LiOH in water at a temperature of 333.15 K=60° C.). Preferably, the concentration of lithium hydroxide in the rich working medium C_{M1}, based on the total weight of the rich working medium, is above 0.138 kg/kg or above 0.146 kg/kg. These values are understood as calculated as the anhydride of LiOH. If the concentration is determined as lithium hydroxide monohydrate, the concentration of lithium hydroxide in the rich working medium C_{M1} should be above 0.23 kg/kg or above 0.256 kg/kg.

The concentration of lithium hydroxide in the poor working medium C_{M0} based on the total weight of the poor working medium should on the other hand be less than 12.8% by weight. This ensures that LiOH is not introduced into the second compartment already in solid form. The lower limit for the LiOH concentration in the poor working medium is 50 ppm. If this is not the case, the reaction does not initiate or proceed.

In relation to the description of the solubility of lithium hydroxide in water, it should be emphasized that the cell does not have to be operated exactly at the solubility limit. It is envisaged that the cell will be operated above the precipitation limit in order that particularly large amounts of LiOH precipitate as a solid. The upper limit for C_{M1} is determined by the pumpability of the rich working medium: If the latter contains too much solid lithium hydroxide, pumping it out of the second compartment will no longer be possible. The LiOH concentrations stated in Table 1 thus correspond to the lower limit for C_{M1}. The upper limit results from the apparatus setup of the plant with which the process according to the invention is executed. In particular, the structural design of the means of conveyance that effects the withdrawal of the rich working medium from the second compartment and its transport to a downstream separation apparatus, are critical for the upper limit. In the realization of the process according to the invention, a separation apparatus is used to separate LiOH from the rich working medium. The means of conveyance and also bottlenecks in the cell and pipe connections can become clogged with crystallizing product and thus also define the technically manageable upper limit for C_{M1}.

Since the inorganic membrane is not sensitive to foreign ions, the feed can contain anions selected from the group consisting of sulfate, carbonate, hydroxide and chloride.

In addition to the anions mentioned, the feed may also contain impurities in the form of compounds of the following elements: B, Na, Mg, Al, Si, K, Ca, Mn, Fe, Co, Ni, Cu, C. The listed alkali metals and alkaline earth metals are elements found alongside lithium in natural deposits, while the other metals mentioned are used as conductive or cathode materials in LIBs and are consequently present in feeds obtained from the reprocessing of used LIBs. The carbon is also found in recyclable material streams from the reprocessing of used LIBs and originates from polymeric constituents of battery cells, for example from films, separators, adhesives or sealants.

According to the invention, a membrane is used that includes an inorganic material. The required ion selectivity is thus achieved differently than in the case of polymer membranes. The membrane preferably consists entirely of the inorganic material. Composite membranes that contain the inorganic material solely as a coating on a support material or in which the inorganic material is dispersed in a matrix material of a different type have proved the wrong approach.

In order for the process to work, the inorganic material must conduct Li ions and at the same time act as an electrical insulator. The specific conductivity for electrons g (electrical conductivity) should at a temperature of 23° C. be less than 10⁻⁷ S/cm (10⁻⁹ S/m) or less than 10⁻¹² S/m or less than 10⁻¹⁶ S/m. From an electron conducting point of view, the inorganic material is therefore classified as a non-conductor.

The specific conductivity s of the inorganic material for Li ions should at a temperature of 23° C. be at least 1*10⁻⁵ S/m or at least 5*10⁻⁵ S/m or at least 10*10⁻⁵ S/m and not more than 100*10⁻⁵ S/m. The Li conductivity of the material is measured by impedance spectroscopy. This measurement takes place as follows:

The measurement setup comprises two cylindrical electrodes, with the sample arranged therebetween. To ensure optimal contact with the electrodes and reproducible contact pressure, a weight is placed on the sample.

A potentiostat (Zahner-Elektrik I. Zahner-Schiller GmbH & Co. KG, Kronach-Gundelsdorf, Germany) is connected to the electrodes and controlled via the Thales software (Zahner). The measurements are carried out in a frequency range from 1 Hz to 4 MHz and at an amplitude of 5 mV using samples that had been polished and sputtered onto a thin conductive gold layer.

The results of the measurements are presented in the form of Nyquist plots and evaluated using the analysis software (Zahner). The electrical resistance is read at the maximum of the curve of the Nyquist plot. The specific ion conductivity σ [mS/cm] is then calculated using the formula σ=(h·10⁴)/(R·π/4·d²), where h is the height of the sample in mm, R the measured electrical resistance in Ω and d the diameter of the sample in mm.

Preference is given to using an LiSICon as the inorganic material. LiSICon materials are glass-ceramic substances that conduct lithium ions and at the same time act as electrical insulators. All known LiSICon materials can in principle be used as the inorganic material for the purposes of the invention. Known LiSICon materials meet the requirements specified above both for the electrical conductivity and for the ion conductivity of the inorganic material.

For example, the LiSICon material lithium aluminium titanium phosphate (LATP) may be used. Accordingly, in one variant of the invention the inorganic material is a compound of the following stoichiometry:

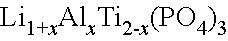

where: 0.1≤x≤0.3, where preferably x=0.3.

Alternatively, the LiSICon material lithium aluminium titanium silicon phosphate (LATSP) may be used. Accordingly, in one variant of the invention the inorganic material is a compound of the following stoichiometry:

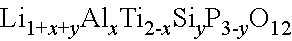

where: 0.1≤x≤0.3 and 0.2≤y≤0.

In a particularly preferred development of the invention, an LATSP that additionally contains germanium is used. A LAGTSP is for example obtainable from OHARA GmbH, Hofheim, Germany under the product name LICGC® AG01.

The stoichiometry of LAGTSP is:

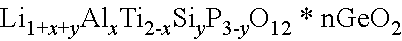

where: 0≤x≤1 and 0≤y≤1 and 0≤n≤1.

Alternatively, the LiSICon material lithium aluminium germanium phosphate (LAGP) may be used. Accordingly, in one variant of the invention the inorganic material is a compound of the following stoichiometry:

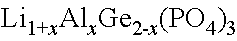

where: x=0 or x=0.2 or x=0.4.

Particular preference is however given to using an LiSICon that is derived from lithium aluminium germanium phosphate (LAGP) but additionally contains titanium. This is referred to as an LAGTP.

Accordingly, in a preferred variant of the invention the inorganic material is a compound of the following stoichiometry:

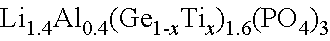

where: 0≤x≤1.

As an alternative to the phosphates mentioned above, the oxidic LiSICon material lithium lanthanum titanium oxide (LLTO) may be used. Accordingly, in one variant of the invention the inorganic material is a compound of the following stoichiometry:

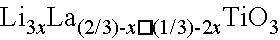

where: 0≤x≤0.16.

The lithium hydroxide is present in the rich working medium and is withdrawn with this from the second compartment. In order to be able to make use of it, it needs to be separated from the rich working medium. A separation apparatus is provided for this purpose. A preferred development of the invention accordingly includes the following additional process steps:
k) providing a separation apparatus;
l) separating the lithium hydroxide from the rich working medium with the aid of the separation apparatus.

The process is preferably operated in such a way that the separation apparatus separates a product having the following composition:
Lithium hydroxide: >56.5% by weight
Water: <43.5% by weight
Carbon dioxide: <0.35% by weight
Sulfur dioxide: <0.01% by weight
Chlorine: <0,002% by weight
Calcium: <15 ppm by weight
Iron: <5 ppm by weight
Sodium: <20 ppm by weight
Aluminium: <10 ppm by weight
Chromium: <5 ppm by weight
Potassium: <10 ppm by weight
Copper: <5 ppm by weight
Nickel: <10 ppm by weight
Silicon: <30 ppm by weight
Zinc: <10 ppm by weight
Other substances: <10% by weight
   where the parts by weight add up to 100% and are based on the total weight of the product. A product of this kind is battery-grade LiOH and can be used directly in the production of LIBs.

The product separated in the separation apparatus contains solid lithium hydroxide. The product preferably meets the above specification in order that it can be used directly as battery-grade LiOH for the production of new LIBs. However, the separated product is not pure LiOH; the principle by which it is formed means that the separated product will always contain water, which is trapped in the LiOH crystals (water of crystallization/internal water). The water content of the separated product is however below 43.5% by weight and therefore meets the battery-grade specification. At this water content, the separated product is a crystalline solid and not a gel.

The working medium freed from the LiOH in the separation apparatus is conveyed back to the electrochemical cell as poor working medium, where it is reloaded. The working medium therefore recirculates in a closed system. The resulting recirculation of the working medium is between the second compartment and the separation apparatus. The recycling of the working medium brings savings both in the supply of fresh water and the disposal of wastewater.

It is important that the poor working medium is not completely free of LiOH, but has a certain minimum concentration C_{M0} of about 50 ppm by weight. If this is not the case, it is not possible for the process in the cell to be maintained continuously. The separation apparatus therefore does not completely separate the LiOH present in the rich working medium, but leaves a residual concentration in the working medium. The separation apparatus preferably separates only solid LiOH and leaves behind dissolved LiOH in the working medium as the initial concentration C_{M0}.

A preferred development of the invention accordingly includes the following additional process steps:
l) separating the lithium hydroxide from the rich working medium with the aid of the separation apparatus so as to afford the poor working medium,
   wherein the step
b) providing a poor working medium comprising water and lithium hydroxide dissolved therein, the concentration of lithium hydroxide in the poor working medium C_{M0}, based on the total weight of the poor working medium, being at least 50 ppm by weight;
takes place with the aid of the separation apparatus.

In order for recirculation of the working medium between the separation apparatus and the second compartment to be possible, it makes sense for both apparatuses to be installed in the same location. The same location is to be understood as meaning an integrated production facility. The electrochemical cell and separation apparatus are consequently part of an integrated facility. The closed recirculation of the working medium allows the electrochemical cell and separation apparatus to be installed in the same location and operated continuously. The process is preferably incorporated directly into an integrated plant that includes a unit for reprocessing used LIBs and a unit for producing new LIBs. However, it is also possible to simply combine the process with a battery recycling plant and export the LiOH obtained.

It is also conceivable for the separation apparatus to be situated away from the electrochemical cell, in a different location. In that case it is however necessary for the working medium to be transported between the cell and the separation apparatus. However, this makes very little sense from an energetic point of view.

It is preferable that at least the electrochemical cell is operated continuously. This means there is a constant through-flow between the two compartments. The first compartment has a continuous through-flow of the feed, resulting in the generation of wastewater, whereas the second compartment has a through-flow of working medium, which flows in as poor working medium and flows out as rich working medium. This makes possible both a higher throughput and the continuous withdrawal of membrane-damaging constituents in the feed and working medium. Continuous operation can therefore be expected to achieve better membrane stability than in batchwise operation.

In a preferred embodiment of the process it is therefore envisaged that at least the process steps of
i) withdrawing from the second compartment of a rich working medium comprising water, hydrogen and lithium hydroxide;
   and
l) separating the lithium hydroxide from the rich working medium with the aid of the separation apparatus;
   take place continuously.

Since the LiOH accumulates in solid form in the process according to the invention, the separation apparatus is preferably designed as a solids separator. Suitable solid separators are filters, hydrocyclones and sedimentation separators. These devices do not require thermal energy. Consequently, the process described herein requires primarily the electrical energy to operate the electrochemical cell and secondary electrical energy to convey the material streams. The process can therefore preferably be operated with green electricity.

### DESCRIPTION OF FIGURES

The invention will now be elucidated in detail with reference to process flow diagrams. In the figures provided for this purpose:

FIG. 1: shows the functional principle of the simultaneous membrane electrolysis of Li⁺ and water electrolysis in the electrochemical cell with LiSICon membrane;

FIG. 2: shows the functional principle of the recirculation between the electrochemical cell and separation apparatus.

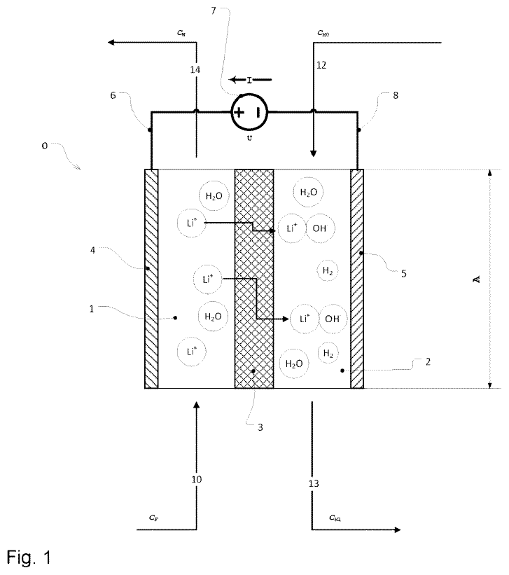

The electrochemical cell 0 necessary for the performance of the process is shown in FIG. 1. It includes a first compartment 1 and a second compartment 2. The two compartments 1 and 2 are separated from one another by a membrane 3. Arranged in the first compartment 1 is an anode 4. Arranged in the second compartment 2 is an cathode 5. The first compartment 1 can therefore be referred to as the anodic compartment and the second compartment 2 as the cathodic compartment.

A first electrical lead 6 connects the anode 4 with a voltage source 7. A second electrical lead 8 connects the cathode 5 with the voltage source 7. The chosen polarity of the voltage source 7 is such that the positive pole of the voltage source 7 is connected to the anode 4 and the negative pole of the voltage source 7 to the cathode 5.

An electric current/flows through the two electrical leads 6 and 8 and via the electrical voltage source 7. Since the membrane 3 acts as an electrical insulator, there is no electrical short circuit between the two electrodes 4 and 5 via the membrane 3.

The membrane 3 is a flat-sheet membrane that consists entirely of an LiSICon material. The anode 4 is a flat metal plate comprising titanium, niobium or tantalum. The cathode 5 is likewise a flat metal plate comprising titanium or nickel. In the simplest case, stainless steel plate is used as the cathode. Anode 4, cathode 5 and membrane 3 have the same shape and may be rectangular or circular. This is not apparent from the side view in FIG. 1. Instead of metal plates, it is also possible to use expanded metals, mesh or nets of the specified materials as electrodes.

The electrochemical cell 0 has an active area A that corresponds to the surface area of the membrane 3, anode 4 and cathode 5.

During operation, the first compartment 1 is charged with a feed 10. The feed 10 is an aqueous solution containing Li+ ions. From an electrochemical point of view, the feed 10 is regarded as the anolyte.

The feed 10 may be an Li leach liquor from a natural deposit or a material stream arising from the reprocessing of used LIBs. The concentration of Li+ cations in the feed 10 (formula symbol c_{F}) should be at least 200 ppm by weight based on the total mass of the feed. Seawater has a lower Li concentration and must therefore first be concentrated before it is used in the process. The feed 10 also contains anions such as sulfate or chloride. The feed 10 also contains impurities. Anions and impurities are not shown in FIG. 1. The main component of the feed 10 is water H₂O.

The second compartment is charged with a poor working medium 12. The poor working medium 12 is water H₂O having a low concentration C_{M0} of Li⁺ cations. The concentration C_{M0} is at least 50 ppm by weight based on the total mass of the poor working medium 12. From an electrochemical point of view, the poor working medium 12 is regarded as the catholyte.

The electrochemical cell 0 is also charged with an electrical voltage U drawn from a voltage source 7. This has the following effect:

Firstly, an electrolysis of water takes place in which water (H₂O) is split electrochemically into hydrogen (H₂) and oxygen (O₂). At the cathode 5, OH⁻ and hydrogen are formed. The OH anions are however unable to cross the membrane 3 and combine with the Li⁺ cations present in the cathodic compartment 2 to form lithium hydroxide (LiOH). At the anode 4, oxygen and H⁺ are formed.

The formation of LiOH in the cathodic compartment 2 is maintained by the migration to the cathode 5 of Li+ cations from the feed 10 driven by the voltage U. They cross the membrane 3 by virtue of the conductivity for Li ions of the membrane and accumulate in the working medium (membrane electrolysis). This results in the formation of a rich working medium 13, which is drawn off from the second compartment 2. The concentration of Li+ ions in the rich working medium 13 is greater than in the poor working medium 12, thus c_{M1}>c_{M0}.

Thus, a water electrolysis, a membrane electrolysis of Li⁺ and a synthesis of LiOH proceed simultaneously in the electrochemical cell.

The simultaneous operation of the Li+ membrane electrolysis and water electrolysis in the electrochemical cell thus results in the direct formation of lithium hydroxide LiOH and molecular hydrogen H₂. The hydrogen is at least partly dissolved; it may also be present in the form of gas bubbles. The lithium hydroxide is according to the invention concentrated to above its solubility. This means that the lithium hydroxide is present at least partly in solid form in the rich working medium 13.

Depending on the temperature and on the presence of crystallization nuclei, the LiOH precipitates already in the second compartment 2 or immediately after withdrawal of the rich working medium 13. Impurities typically act as crystallization nuclei.

As a result of the membrane electrolysis the feed 10 becomes depleted in Li+, giving rise to wastewater 14. Thus, c_{W}<c_{F}. The formula symbol c_{W} here represents the concentration of Li ions in the wastewater 14 based on the total mass of the wastewater 14. The formula symbol c_{F} here represents the concentration of Li ions in the feed 10 based on the total mass of the feed 10.

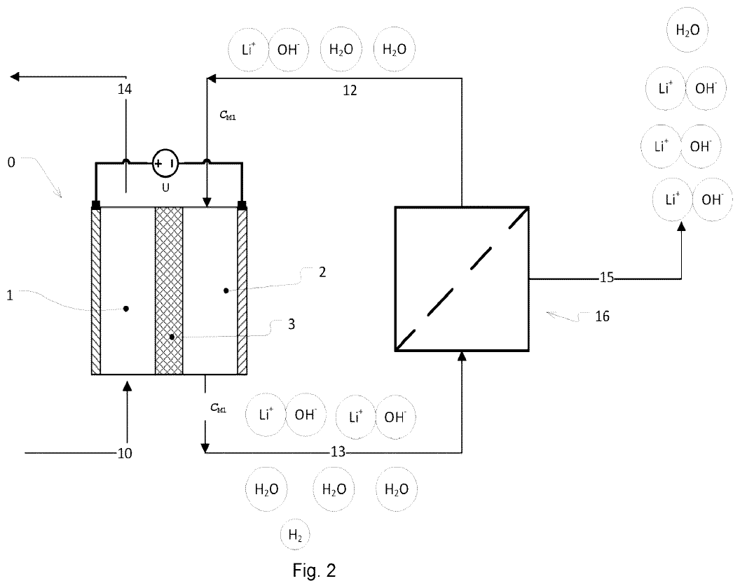

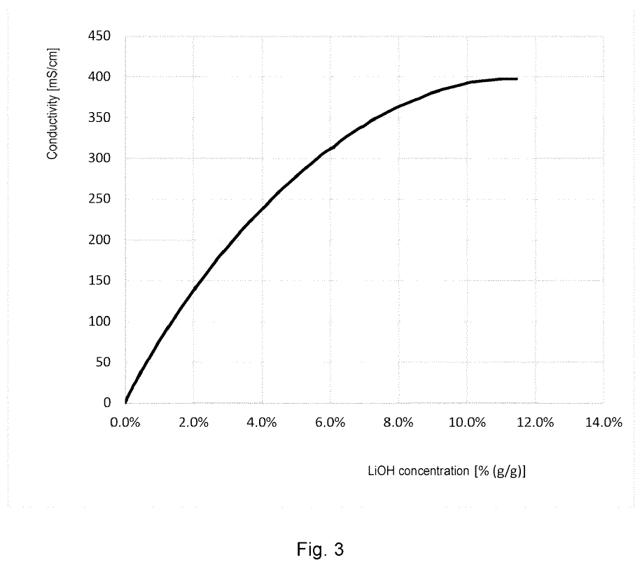

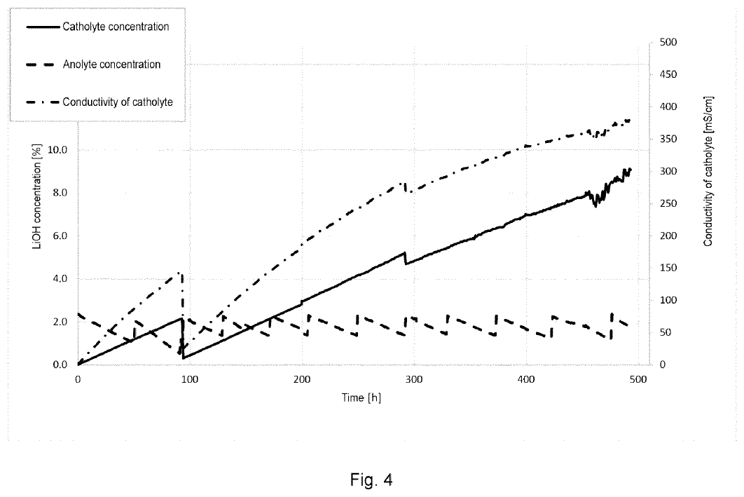

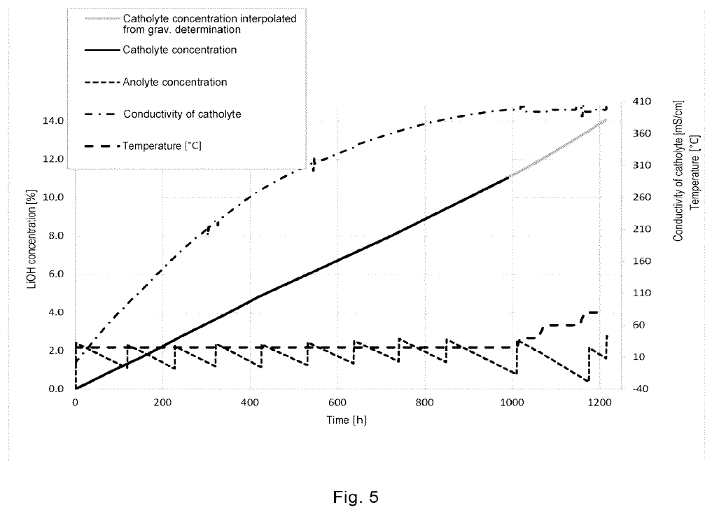

FIG. 2 depicts how the LiOH is extracted as the target product 15 from the rich working medium 13.

For this purpose, a separation apparatus 16 is provided into which the rich working medium 13 is conveyed. The separation apparatus 16 separates from the rich working medium 13 the target product 15, which has a particularly high concentration of LiOH. The target product also contains water and impurities, depending on the desired specification of the target product.

Because the rich working medium 13 contains LiOH in solid form, the separation apparatus 16 is preferably a solids separator such as a filter. The solid LiOH is filtered out of the rich working medium 13 and corresponds to the actual product of the process.

The LiOH-depleted output stream from the separation apparatus 16 is recycled as poor working medium 12 to the second compartment 2 of the electrochemical cell 0.

As mentioned previously, the poor working medium 12 needs to have a certain LiOH concentration C_{M0} in order that the process in the electrochemical cell 0 can be initiated in the desired manner by virtue of the low initial resistance. The concentration c_{M0} should be at least 50 ppm by weight based on the total mass of the poor working medium 12. In order to ensure the desired concentration C_{M0}, the separation apparatus 16 is operated such that the not all the LiOH is separated from the rich working medium 13. This is particularly easy when using a solids separator, because the dissolved parts of the LiOH are left by the latter in the working medium and can be recycled into the second compartment 2 with the required starting concentration of more than 50 ppm.

In addition to lithium hydroxide LiOH the process also generates H₂. The hydrogen H2 is at least partly dissolved in the rich working medium 13 and is withdrawn together with the LiOH from the second compartment 2.

Since the hydrogen H₂ is easily degassed from the water, it does not require much effort to remove it from the rich working medium. It is only if the hydrogen H₂ is to be utilized as a second target product that a corresponding second separation apparatus is provided with which the hydrogen is separately obtained in an appropriate quality/purity (not depicted).

The water H₂O, present in the rich working medium 13 is recycled as completely as possible as poor working medium 12. Only the water (of crystallization) present in the target product 15 is lost from the process. This must be replenished in the poor working medium 12 as required (not depicted). The water in the feed 10 does not end up being recirculated between the second compartment 2 and the separation apparatus 16, because the membrane 3 is impermeable to water.

### Experiments:

The effects achieved with the invention will now be elucidated with reference to experiments.

For the performance of the electrolysis, the electrolysis cell is first assembled and the anolyte and catholyte containers connected. Care is taken to ensure here that the inflow and return flow are in each case connected on the same side.

The anode and cathode used were in each case a round disc having a diameter of 19.5 mm and a thickness of 1 mm. The material was in each case a titanium expanded metal plate coated on both sides with IrTi mixed oxide, 12 g Ir/m2, 1 AF D 1.5 mm from Metakem GmbH, 61250 Usingen, Germany.

The membranes sampled were likewise circular discs about 25 mm in diameter. The thickness of the membranes was about 1 mm. The material of the membranes sampled was a LATSP, namely LICGC® PW01 from Ohara GmbH, Hofheim, Germany.

The electrolysis and the corresponding reservoir containers are blanketed with nitrogen for the entire duration of the process in order to prevent the formation of lithium carbonate. Each cell has a separate anolyte container and separate catholyte container. Each container is filled with about 1 kg of liquid; the exact mass is determined by reweighing. In all experiments the catholyte was always a 5 mmol/L LiOH solution (corresponding to 120 ppm by weight LiOH). The anolyte is in each case a lithium salt solution in various concentrations and with various lithium salts. The starting concentration was in each case 1.0 mol/L LiOH. The exact concentration varies in the course of the experiment and is therefore also shown in the figure for the experiments.

On switching on the pumps and applying the desired voltage, the experiment commences. The maximum flow rate is 900 mL/minute. Samples are collected every half hour or at longer intervals if this has been agreed. The first 3 mL of sample collected is discarded. For each sample collected, the power is in each case noted and the pH and conductivity of the sample determined. The samples are then returned to the appropriate container so as to keep the volume virtually constant.

At the end of the experiment, the containers are emptied and all leads and also the membrane are rinsed with demineralized water. The cells are dismantled, the membrane is photographed and SEM images of the catholyte side and anolyte side recorded to document any damage or changes to the membrane.

The membrane performance is measured by the parameters permeability (g Li*mm/m²*h) and permeance (g Li/m²*h). The permeance indicates how much mass of lithium per unit membrane area and per unit time is being transported through the membrane. The permeability takes account also of the membrane thickness and thus makes it possible also to compare different membrane types having different thicknesses. For a comprehensive description of the performance both are required, since extremely thin membranes would permit enormously high permeance, but if concentration polarization effects were present in the membrane cell the permeabilities would give an inaccurate picture. Taking account of the membrane thickness would then no longer serve any useful purpose, since transport would not be limited by the membrane.

All measured values shown in the examples are subject to a measurement error of approx. ±10% attributable to imprecision in the positioning of the electrodes with respect to one another, in the determinations of the thickness of the membrane samples, and in the determination of the concentration via conductivity measurements.

The concentration was determined inline via a conductivity measurement. The conductivity is in the experiment results converted into a concentration via the calibration curve shown in FIG. 3.

FIG. 3: Conductivity as a function of the concentration of a LiOH solution (25° C.)

This does however mean that at concentrations above approx. 10% LiOH it is almost impossible to accurately monitor the actual concentration via conductivity measurements.

### First Experiment:

A first experiment seeking to increase the concentration to more than 10% LiOH is summarized in Table 2 and FIG. 4; account had to be taken here of the reduced accuracy of the determination of concentration via conductivity determination.

TABLE 2
Experimental parameters

| Membrane material | LATSP (Ohara) |
|---|---|
| Membrane thickness [mm] | 2.0 |
| Membrane diameter [mm] | 100 |
| Membrane area [cm2] | 70.88 |
| Voltage [V] | 6.0 |
| Current yield [%] | 94% |
| Permeance (g Li/(m² · h)) | 8.11 |
| Electrolysis time [h] | 493 |
| Temperature [° C.] | 24 to 27 |

FIG. 4: Results of the experiment in graph form

The jagged course of the anolyte conductivity evident in FIG. 4 is due to the regular renewal of the anolyte when it has reached a concentration of less than approximately half the starting concentration. After about 100 hours, the catholyte had to be replaced because the cell was leaking. This then led to the concentration and thus the conductivity of the catholyte solution falling very sharply. This experiment showed that with this operating procedure the lithium hydroxide concentration could be increased well above the starting concentration of the anolyte. The experiment was terminated after a run time of approx. 500 hours, at a lithium hydroxide content of approx. 9%, since a differentiated evaluation of the lithium hydroxide concentration was not possible. The catholyte had a temperature of 27° C. and solid lithium hydroxide did not form.

### Second Experiment:

A repeat experiment with the same prescriptions as in Table 2 led to the following result:
FIG. 5: Results of the repeat experiment in graph form

In FIG. 5 too, the regular renewal of the anolyte solution is evident in the jagged course of the conductivity measurement in the anolyte. The catholyte conductivity increases over a period of approx. 1000 hours up to a limit of approx. 395 to 400 mS/cm, which results from the solubility and electrical properties of a lithium hydroxide solution at a temperature of approx. 25° C. Since, as already described above, the exact concentration cannot be determined via the conductivity, a sample was taken after approx. 1010 hours of operating time and the lithium hydroxide content determined gravimetrically.

The temperature of the anolyte and the catholyte was then raised to 40° C. and the electrolysis continued. In the conductivity determination, a temperature correction as specified by the manufacturer of the measuring device was applied. At this elevated temperature, the conductivity (with temperature correction) did not increase any further and thus remained at approx. 400 mS/cm.

After continued operation of the electrolysis for 48 hours, the saturation limit of lithium hydroxide at a temperature of 40° C. should be reached. A further sample was therefore taken from the catholyte circulation and the lithium hydroxide content of this determined gravimetrically.

The temperature of both circulations was then raised to 60° C. and the electrolysis continued. After about another 90 hours, the saturation concentration for this temperature should again be reached, which should be confirmed by sampling and gravimetric determination of the solids content. With a final increase in temperature to 80° C. and continued operation up to the desired saturation concentration for the planned period of approx. 110 hours, the measuring apparatus developed a leak after approx. 60 hours that prevented the experiment from being concluded. A sample was taken to determine the solids content.

The remaining catholyte was then drained off, cooled to room temperature under a nitrogen atmosphere and left to stand for some time to allow some of the lithium hydroxide from the solution, which was now held at 20° C., to settle as a white deposit. All work to determine the concentration was carried out with the exclusion of carbon dioxide and with nitrogen blanketing.

The results of the individual content determinations are summarized in Table 3. They reflect the amount of lithium hydroxide in the solution at the end of each temperature level as determined by sampling. The average permeabilities are calculated from the contents determined, the electrolysis time and the area of the membrane used.

TABLE 3
Lithium hydroxide contents of the different samples

| | | LiOH | Average | Solubility* at |
|---|---|---|---|---|
| Run | Temperature | content | permeability | the temperature |
| time [h] | level [° C.] | [% (g/g)] | [g/m² h] | [% (g/g)] |
| 1010 | 25 | 11.2 | 7.9 | 11.1 |
| 1058 | 40 | 11.9 | 8.7 | 11.7 |
| 1148 | 60 | 13.1 | 9.7 | 12.8 |
| 1210 | 80 | 14.0 | 10.1 | 14.2 |

*The solubilities of LiOH were taken from Table 1.

From Table 3 it can be soon that the LiOH content was run up to about 0.1-0.3% above the saturation limit. Cooling resulted in the formation of solid LiOH·H2O.

### CONCLUSION

The experiments demonstrate that it is possible to run the process beyond the solubility limit of LIOH in the cell. This means that solid LiOH can be produced with the electrochemical cell alone.

### LIST OF REFERENCE SYMBOLS

0 Electrochemical cell
1 First compartment
2 Second compartment
3 Membrane
4 Anode
5 Cathode
6 First electrical lead
7 Voltage source
8 Second electrical lead
9 Not assigned
10 Feed
11 Not assigned
12 Poor working medium
13 Rich working medium
14 Wastewater
15 Target product
16 Separation apparatus
H₂O Water
H₂ Hydrogen
O₂ Oxygen
LiOH Lithium hydroxide
OH⁻ OH anions
Li⁺ Lithium cations
U Electrical voltage
I Electric current
A Active area
C_{F} LiOH concentration in feed
C_{W} LiOH concentration in wastewater
C_{M0} LiOH concentration in poor working medium
C_{M1} LiOH concentration in rich working medium

1. Process for producing hydrogen and lithium hydroxide, comprising the following steps:
a) providing a feed comprising at least water, Li ions and also impurities, the concentration of Li ions in the feed C_{F} being at least 200 ppm by weight or between 500 ppm by weight and 140 000 ppm by weight, in each case based on the total weight of the feed;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing at least one electrochemical cell, wherein the electrochemical cell has the following properties:
i. the electrochemical cell includes a first compartment in which an anode is arranged;
ii. the electrochemical cell includes a second compartment in which a cathode is arranged;
iii. the electrochemical cell includes a membrane that separates the first membrane from the second membrane, the membrane having the area A;
iv. the membrane comprises an inorganic material that possesses conductivity for Li ions and that is electrically insulating;
d) providing at least one electrical voltage source that is connected to the anode via a first electrical lead and to the cathode via a second electrical lead;
e) charging of the first compartment with the feed;
f) charging of the second compartment with the poor working medium;
g) charging of the electrochemical cell with an electrical voltage U drawn from the electrical voltage source such that an electrical current/flows between the anode and cathode, the ratio Q of the current strength of the electrical current/and the area A of the membrane being between 100 A/m² and 500 A/m² or between 150 A/m² and 350 A/m²;
h) withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F} based on the total weight of the feed;
i) withdrawing from the second compartment of a rich working medium comprising water, hydrogen and lithium hydroxide, wherein the concentration of lithium hydroxide in the rich working medium C_{M1} based on the total weight of the rich working medium is greater than the concentration of lithium hydroxide in the poor working medium C_{M0} based on the total weight of the poor working medium, and wherein the concentration of lithium hydroxide in the rich working medium C_{M1} based on the total weight of the rich working medium is greater than the solubility of lithium hydroxide in water at a temperature T_{M1}, where the temperature T_{M1} refers to the temperature of the rich working medium at the time of its withdrawal from the second compartment.

2. Process according to claim 1, wherein the rich working medium contains solid lithium hydroxide at the time of its withdrawal from the second compartment.

3. Process according to claim 1, wherein the temperature T_{M1} of the rich working medium at the time of its withdrawal from the second compartment is between 20° C. and 60° C.

4. Process according to claim 3, wherein
the concentration of lithium hydroxide in the rich working medium C_{M1} based on the total weight of the rich working medium is greater than 0.1276 kg/kg or greater than 0.138 kg/kg or greater than 0.146 kg/kg, in each case calculated as LiOH;
or
the concentration of lithium hydroxide in the rich working medium C_{M1} based on the total weight of the rich working medium is greater than 0.21 kg/kg or greater than 0.231 kg/kg, in each case calculated as LiOH·H₂O.

5. Process according to claim 1, wherein the concentration of lithium hydroxide in the poor working medium C_{M0} based on the total weight of the poor working medium is less than 12.8% by weight.

6. Process according to claim 1, wherein the feed contains anions selected from the group consisting of sulfate, carbonate, hydroxide and chloride.

7. Process according to claim 1, wherein the feed contains impurities in the form of compounds of elements selected from the group consisting of B, Na, Mg, Al, Si, K, Ca, Mn, Fe, Co, Ni, Cu and C.

8. Process according to claim 1, wherein the inorganic material present in the membrane possesses a conductivity for Li ions, measured by the “impedance spectroscopy” method described herein, that at a temperature of 23° C. is at least 1*10⁻⁵ S/m or at least 5*10⁻⁵ S/m or at least 10*10⁻⁵ S/m and not more than 100*10⁻⁵ S/m.

9. Process according to claim 8, wherein the inorganic material is a compound of the following stoichiometry (LATP): 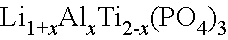
where: 0.1≤x≤0.3, where preferably x=0.3.

10. Process according to claim 8, wherein the inorganic material is a compound of the following stoichiometry (LATSP): 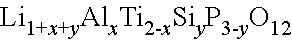
where: 0.1≤x≤0.3 and 0.2≤y≤0.4.

11. Process according to claim 8, wherein the inorganic material is a compound of the following stoichiometry (LAGTSP): 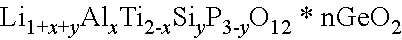
where: 0≤x≤1 and 0≤y≤1 and 0≤n≤1

12. Process according to claim 8, wherein the inorganic material is a compound of the following stoichiometry (LAGTP): 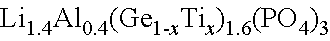
where: 0≤x≤1.

13. Process according to claim 8, wherein the inorganic material is a compound of the following stoichiometry (LAGP): 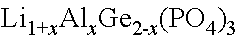
where: x=0 or x=0.2 or x=0.4.

14. Process according to claim 8, wherein the inorganic material is a compound of the following stoichiometry (LLTO): 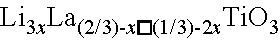
where: 0≤x≤0.16.

15. Process according to claim 1, comprising the additional steps of:
k) providing a separation apparatus;
l) separating the lithium hydroxide from the rich working medium with the aid of the separation apparatus.

16. Process according to claim 15, wherein in the step
l) separating the lithium hydroxide from the rich working medium with the aid of the separation apparatus,
a product having the following composition is obtained:
Lithium hydroxide: >56.5% by weight
Water: <43.5% by weight
Carbon dioxide: <0.35% by weight
Sulfur dioxide: <0.01% by weight
Chlorine: <0,002% by weight
Calcium: <15 ppm by weight
Iron: <5 ppm by weight
Sodium: <20 ppm by weight
Aluminium: <10 ppm by weight
Chromium: <5 ppm by weight
Potassium: <10 ppm by weight
Copper: <5 ppm by weight
Nickel: <10 ppm by weight
Silicon: <30 ppm by weight
Zinc: <10 ppm by weight
Other substances: <10% by weight
where the parts by weight add up to 100% and are based on the total weight of the product.

17. Process according to claim 15, wherein the step
l) separating the lithium hydroxide from the rich working medium with the aid of the separation apparatus;
affords the poor working medium such that the step
b) providing a poor working medium comprising water and lithium hydroxide dissolved therein, the concentration of lithium hydroxide in the poor working medium C_{M0}, based on the total weight of the poor working medium, being at least 50 ppm by weight;
takes place with the aid of the separation apparatus.

18. Process according to claim 15, wherein in that the electrochemical cell and the separation apparatus are provided in the same location.

19. Process according to claim 18, wherein at least the process steps
i) withdrawing from the second compartment of a rich working medium comprising water, hydrogen and lithium hydroxide;
and
l) separating the lithium hydroxide from the rich working medium with the aid of the separation apparatus;
take place continuously.

20. Process according to claim 15, wherein the separation apparatus is a solids separator.

21. Process according to claim 20, wherein the separation apparatus is selected from the group consisting of the following solids separators: filter, hydrocyclone, sedimentation separator.
